(19) United States
(12) Patent Application Publication
(10) Pub. No.: US 2025/0389640 A1
(43) Pub. Date: Dec. 25, 2025

(54) MULTI-LEVEL AND MULTI-PARAMETER COUPLING REGULATION METHOD, DEVICE, ELECTRONIC EQUIPMENT AND STORAGE MEDIUM

(71) Applicant: SHANGHAI INSTITUTE OF TECHNICAL PHYSICS CHINESE ACADEMY OF SCIENCES, Shanghai (CN)

(72) Inventors: Jinning Li, Shanghai (CN); Zhiping He, Shanghai (CN); Rui Xu, Shanghai (CN); Meizhu Wang, Shanghai (CN); Feifei Li, Shanghai (CN)

(21) Appl. No.: 19/235,804

(22) Filed: Jun. 12, 2025

(30) Foreign Application Priority Data
Jun. 21, 2024 (CN) 202410807750.3

(51) Int. Cl. G01N 21/17; G06F 17/11

(52) U.S. Cl. CPC G01N 21/17; G06F 17/11; G01N 2201/125

(57) ABSTRACT

A multi-level and multi-parameter coupling regulation method includes the following steps: acquiring multi-source scene data, analyzing the multi-source scene data, and generating scene analysis information; calculating adjustment weights of preset adjustable parameters according to the multi-source scene data; calculating adjustment values of the adjustable parameters through a swarm intelligence optimization algorithm according to the scene analysis information and the adjustment weights; adjusting the adjustable parameters according to the adjustment values.

### CROSS-REFERENCE TO RELATED APPLICATIONS

This application claims the priority and benefit of Chinese patent application No. 202410807750.3, filed on Jun. 21, 2024. The entirety of Chinese patent application No. 202410807750.3 is hereby incorporated by reference herein and made a part of this specification.

### TECHNICAL FIELD

The present disclosure relates to the field of measurement and analysis method, and in particular to a multi-level and multi-parameter coupling regulation method, device, electronic equipment and storage medium.

### BACKGROUND ART

In-situ spectral detection technology is an effective detection means currently used in lunar and deep space surface exploration missions. It can achieve close-range detection on the surface of extraterrestrial objects to obtain the target's reflection and emission spectral information, so as to accurately understand the target's material composition and physical property parameters.

Different from laboratory spectral analysis and remote sensing detection scenarios, deep space in-situ spectral detection is particularly affected by scene characteristics. Scene elements such as target characteristics, illumination angle, thermal radiation level, instrument temperature and observation angle are coupled with each other and are complex and changeable. In the same detection scene, strong and weak nonlinear large dynamic signals coexist, and complex time-varying background is often coupled with the target intrinsic signal. This poses a great challenge to the detection sensitivity, dynamic range and other detection capabilities of the in-situ spectroscopy deep space in-situ spectrometer as well as the consistency level. According to different detection scenarios, flexibly adjustment of detection parameters (integration time, gain, modulation frequency, etc.) is one of the effective means to improve the detection capability of deep space in-situ spectrometers. However, limited by the current level of understanding of the interaction mechanism between deep space scene elements and spectral detection links, as well as the constraints of resources such as weight, power consumption, computing power, and communication capabilities of deep space in-situ spectrometers, most parameters are fixed or are evaluated and adjusted relying on the engineering experience of R&D personnel. As a result, it is difficult to take into account both detection sensitivity and dynamic range in different scenarios, and it is difficult to further improve spectral detection capabilities.

At present, some studies have paid attention to the impact of scene elements on spectral detection links and carried out research on related automatic parameter control methods. For example, an infrared imaging spectrometer based on Fourier spectroscopy can realize ambient remote sensing detection in the 2-15 μm spectral band. The equipment has developed an embedded adaptive control system that can automatically perform operations such as resampling, fast Fourier transform (FFT), averaging and dispersion correction based on the data acquired in orbit. The fiber optic spectroscopy system used in the polar sea ice environment will be affected by the dual effects of extremely low temperature (−40° C.) and light intensity transmission attenuation between sea ice depths, which will affect the signal-to-noise ratio of the spectral data. Through simulation experiments, the signal output of the spectral system at different integration times, temperatures and incident light intensities as well as the signal-to-noise ratio between the related noise characteristics and the data are studied, and then a measurement method that automatically sets the integration time for any temperature and incident light is proposed, so that the signals of all wavelengths output by the spectrometer are within the linear working range of the instrument, which ensures that the signals at most wavelengths have a high signal-to-noise ratio. In order to solve the problem that the integration time of Raman spectrometer is difficult to control quickly and affects the signal capture efficiency due to the coupling of linear and nonlinear factors such as Raman scattering effect, capture noise, fluorescence effect and spectrometer optical path, a self-correcting fuzzy PID adaptive control method based on model parameters is proposed. By constructing an initial parameter prediction model and combining it with a fuzzy PID controller, the automatic calculation and optimal control of the integration time of the Raman spectrometer are realized. Experimental results show that this method can effectively suppress the coupling influence of linear and nonlinear factors and improve the signal capture efficiency.

However, the above-mentioned technical solutions are mostly aimed at regulating a single parameter, and there is little research on multi-parameter coupling regulation. With the continuous development of deep space exploration, more and more deep space in-situ spectrometers are used in the detection of the surface of extraterrestrial objects. The environment is also more complex and harsher. The computational difficulty and complexity of multi-parameter coupling regulation have been significantly improved. The traditional parameter regulation mode can no longer fully meet the requirements of future deep space exploration and planetary science research for spectral detection capability and high-quality spectral detection data.

### SUMMARY

In order to improve the self-regulation level and detection capability of a deep space in-situ spectrometer, the disclosure provides a multi-level and multi-parameter coupling regulation method, device, electronic equipment and storage medium.

The multi-level and multi-parameter coupling regulation method of the present disclosure includes the following steps:
acquiring multi-source scene data, analyzing the multi-source scene data, and generating scene analysis information;
calculating adjustment weights of preset adjustable parameters according to the multi-source scene data;
calculating adjustment values of the adjustable parameters through a swarm intelligence optimization algorithm according to the scene analysis information and the adjustment weights;
adjusting the adjustable parameters according to the adjustment values.

Specifically, the multi-source scene data includes telemetry data of deep space in-situ spectrometer, current values of the adjustable parameters, and pre-collected spectral data using the current values of the adjustable parameters.

Specifically, when the multi-source scene data is analyzed, extracting a maximum DNₘₐₓ, a minimum DNₘᵢₙ, and an average DNₘₑₐₙ in the pre-collected spectral data, and calculating a signal-to-noise ratio SNR_{y} of the spectral data.

Specifically, optimizing the signal-to-noise ratio SNR_{y} of the spectral data as an objective function of the swarm intelligence optimization algorithm.

Specifically, in the swarm intelligence optimization algorithm, constructing an adjustable parameter function according to adjustable ranges of the adjustable parameters.
constructing a scene characteristic function according to the scene analysis information;
constructing a mathematical model between the signal-to-noise ratio of the spectral data and the adjustable parameter function and the scene characteristic function according to the adjustable parameter function and the scene characteristic function.

Specifically, the adjustable parameters include a spectral detection observation angle, a field diaphragm specification of the deep space in-situ spectrometer, an input RF power of an in-situ spectral spectroscopic part, a modulation frequency of RF power amplifier, a gain of electronics and integration time of detectors.

Specifically, calculating the adjustment weights includes the following steps:
constructing a correlation analysis database of the adjustable parameters, recording changes when a certain adjustable parameter is fixed and other adjustable parameters are changed one by one;
calculating the adjustment weights of each adjustable parameter using the multi-source scene data as input variables based on a fuzzy logic algorithm and outputting them.

The multi-level and multi-parameter coupling regulation device of the present disclosure includes
one or more processors, a memory,
one or more computer programs, wherein the one or more computer programs are stored in the memory, the one or more computer programs include instructions, the instructions are executed by the one or more processors, so that the multi-level and multi-parameter coupling regulation device performs the above-mentioned multi-level and multi-parameter coupling regulation method.

The electronic equipment of the present disclosure includes at least one processors, and a memory communicatively connected to the at least one processors, wherein the memory stores instructions executable by the at least one processors, the instructions are executed by the at least one processors, so that the at least one processors are able to perform the above-mentioned multi-level and multi-parameter coupling regulation method.

The present disclosure also provides a non-transitory computer-readable storage medium storing computer instructions,
wherein the computer instructions are used to enable a computer to perform the above-mentioned multi-level and multi-parameter coupling regulation method.

To sum up, the disclosure includes at least one of the following beneficial technical effects:
1. It can automatically analyze the surrounding environment according to the different environment, adjust the detection parameters independently, improve the detection sensitivity and dynamic range synchronously, and improve the self-adjustment level and detection ability of the deep space in-situ spectrometer.
2. By calculating the adjustment weights, the complexity of coordinated regulation of multiple adjustable parameters is reduced, and efficient and optimal coordinated regulation of multiple adjustable parameters is achieved while ensuring the reduction of computing resources.

### BRIEF DESCRIPTION OF THE DRAWINGS

FIG. 1 is an overall flow chart of Example 1.

FIG. 2 is a flow chart of step S200.

FIG. 3 is a flow chart of steps A210-A220.

FIG. 4 is an overall flow chart of Example 2.

### DETAILED DESCRIPTION

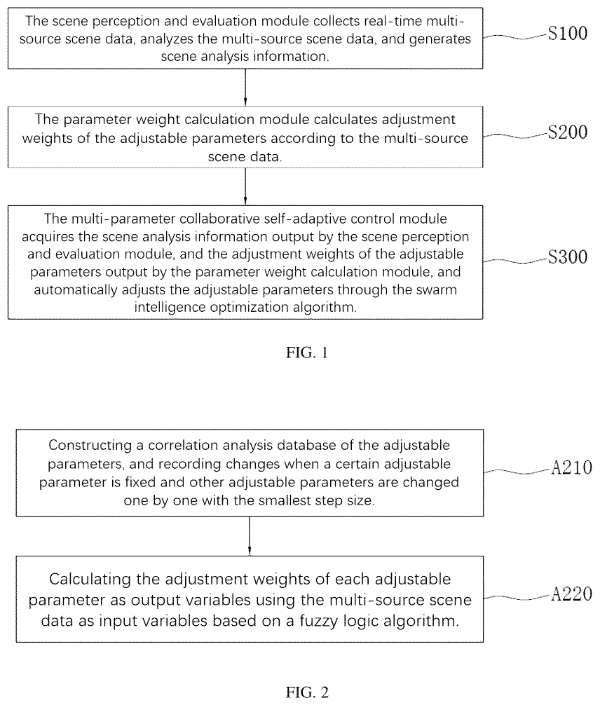

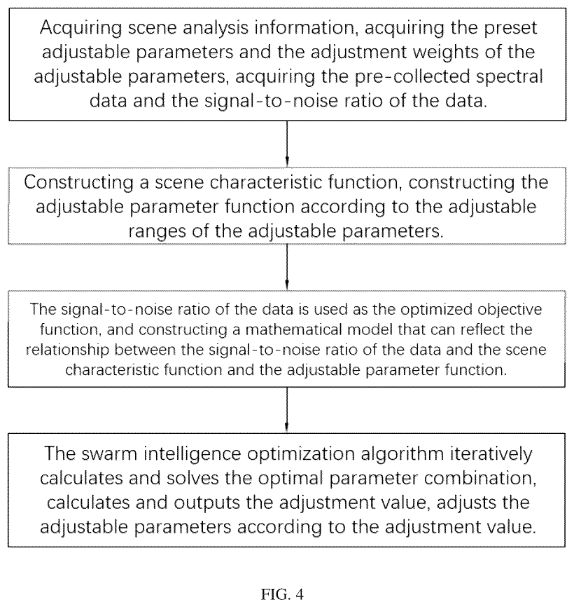

The disclosure will be further described in detail below in combination with FIGS. 1-4.

### Example 1

The multi-level and multi-parameter coupling regulation method provided in the present disclosure can be applied on a server or on a terminal. In particular, the server can be a physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks (CDN), as well as big data and artificial intelligence platforms. The terminal may be a user equipment (UE) such as a mobile phone with strong computing capability, a smart phone, a laptop computer, a digital broadcast receiver, a personal digital assistant (PDA), a tablet computer (PAD), a handheld device, a vehicle-mounted device, a wearable device, a computing device or other processing device connected to a wireless modem, a mobile station (MS), a mobile terminal, etc. The present disclosure is not limited thereto.

Referring to FIG. 1, the multi-level and multi-parameter coupling regulation method includes the following steps:

S100, a scene perception and evaluation module collects real-time multi-source scene data, analyzes the multi-source scene data, and generates scene analysis information.

The multi-source scene data acquired by the scene perception and evaluation module includes telemetry data of deep space in-situ spectrometer, current values of the preset adjustable parameters, and pre-collected spectral data using the current values of the adjustable parameters. In particular, the telemetry data includes the temperature of each part of the in-situ spectrometer measured by thermistors, the primary power supply voltage V₁ of the deep space in-situ spectrometer, the secondary power supply voltage V₂ of the deep space in-situ spectrometer, the current sun altitude angle θ. The temperature of each part of the in-situ spectrometer can be specifically the temperature of the optical base plate T₁, the slit temperature T₂, the spectroscopic part temperature T₃, detector temperature T₄ and electronics temperature T₅.

The adjustable parameters include a spectral detection observation angle α, a field diaphragm specification ϕ of the deep space in-situ spectrometer, an input RF power Gs of an in-situ spectral spectroscopic part, a modulation frequency ft of RF power amplifier, a gain n of electronics and integration time t of detectors. The in-situ spectral spectroscopic part in the present disclosure is an acousto-optic tunable filter, which can adjust the output diffracted light wavelength by changing the RF frequency of the input part, and the change of RF power can adjust the diffraction efficiency.

The pre-collected spectral data is the digital value of the spectral data of each wave band obtained by using preset adjustable parameter, that is, the DN value.

The telemetry data is compared with a preset error range. If there is data in the telemetry data that exceeds the error range, it indicates that the data is noise or abnormal, and the data is then eliminated, thereby removing noise and abnormal values in the telemetry data. The actual value of the adjustable parameter is compared with the preset value of the preset adjustable parameter. If the actual value is different from the preset value, it indicates that the adjustable parameter is noise or abnormal.

The maximum DNₘₐₓ, the minimum DNₘᵢₙ, and the average DNₘₑₐₙ in the pre-collected spectral data are extracted, and the signal-to-noise ratio SNR_{y} of the spectral data is calculated.

The scene perception and evaluation module analyzes the temperature of each part of the in-situ spectrometer in the telemetry data to obtain the temperature information. The observation angle α of spectral detection, the current sun altitude angle θ and the pre-collected spectral data are analyzed to obtain the lighting angle and intensity information. The scene perception and evaluation module extracts different data from multi-source scene data, analyzes and obtains various scene analysis information, and provides important input conditions for subsequent adjustable parameter adjustments.

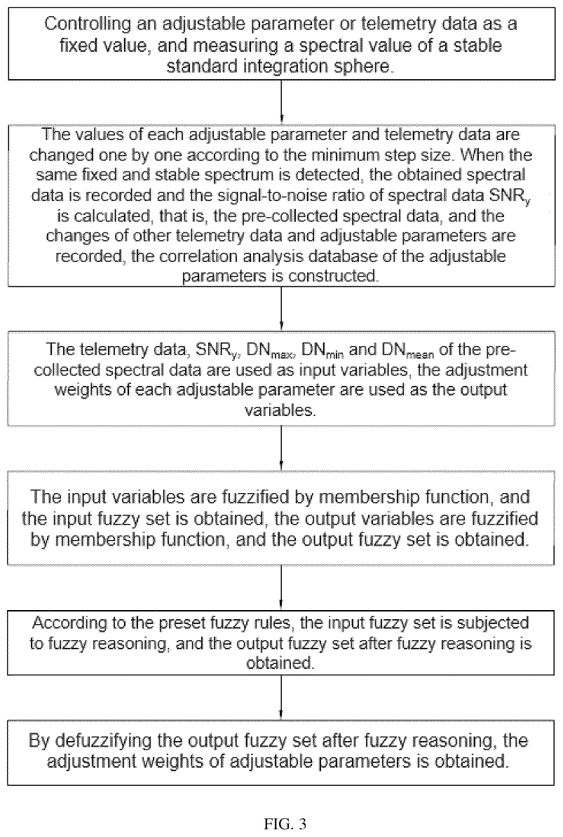

Referring to FIG. 2 and FIG. 3, S200, a parameter weight calculation module calculates adjustment weights of the adjustable parameters according to the multi-source scene data.

A210, constructing a correlation analysis database of the adjustable parameters, and use the adjustable parameter correlation analysis database to recording changes in telemetry data and adjustable parameters when a certain adjustable parameter is fixed and other adjustable parameters are changed one by one with the smallest step size. It is convenient to analyze the impact of a certain adjustable parameter change on other adjustable parameters and telemetry data, and it is convenient to analyze the correlation between multi-source scene data.

A220, calculating the adjustment weights of each obtained adjustable parameter as output variables using the multi-source scene data as input variables. The fuzzy logic algorithm is used to call the data in the correlation analysis database of the adjustable parameters to calculate the spectral detection observation angle adjustment weight W_{α}, the field diaphragm specification adjustment weight W_{ϕ}, the input RF power of the in-situ spectral spectroscopic part adjustment weight W_{Gs}, the modulation frequency of RF power amplifier adjustment weight W_{ft}, the detector integration time adjustment weight Wₜ, and the gain of the electronics adjustment weight Wₙ.

S300, A multi-parameter collaborative self-adaptive control module acquires the scene analysis information output by the scene perception and evaluation module, and the adjustment weights of the adjustable parameters output by the parameter weight calculation module, and automatically adjusts the adjustable parameters through the swarm intelligence optimization algorithm.

The swarm intelligence optimization algorithm optimizes the signal-to-noise ratio of the data as the objective function. The optimization of the signal-to-noise ratio of the data means the obtained signal-to-noise ratio of the data reaches the maximum in the current scene. The swarm intelligence optimization algorithm initializes a group of random solutions at first, each of which represents a possible combination of parameters. Then, through iterative calculations, each solution in the group will be updated according to its own historical optimal solution and the global optimal solution of the group to simulate the search behavior of swarm intelligence. In each iteration, the swarm intelligence optimization algorithm evaluates the performance of the current solution and adjusts the search direction according to the evaluation results, thereby gradually approaching the optimal solution. Through this step-by-step control approach, the swarm intelligence optimization algorithm can quickly find the optimal parameter combination that meets the constraints and achieve optimal control of the overall performance.

To facilitate understanding, an example is given below.

According to the scene analysis information in the step S100, the following scene characteristic function is constructed:

$${f}_{characteristic} = Q ( {T}_{1} , {T}_{2} , {T}_{3} , {T}_{4} , {T}_{5} , {V}_{1} , {V}_{2} , θ , {SNR}_{y} , {DN}_{max} , D {N}_{min} , D {N}_{m e an} )$$

According to the adjustable ranges of the adjustable parameters, the following adjustable parameter function is further constructed:

$${f}_{ad \_ parameter} = P ( α , ϕ , Gs , ft , t , n )$$

A mathematical model between the signal-to-noise ratio of the data, scene characteristics and adjustable parameters is established. The signal-to-noise ratio of the data is used as the optimized objective function to construct the function: ƒ_{SNR} (ƒ_{characteristic}, ƒ_{ad_parameter}), which reflects the relationship between the signal-to-noise ratio of the data and the scene characteristic function ƒ_{characteristic} and the adjustable parameter functions ƒ_{ad_parameter}. It is convenient to analyze the changes in the signal-to-noise ratio of the data after the adjustable parameters change.

The swarm intelligence optimization algorithm chooses the particle swarm optimization algorithm, with the preset swarm size as N, the number of iterations as T, and the adjustment values of the adjustable parameters as the particle. The adjustment values are the minimum step size of the adjustable parameter. The optimal parameter combination is solved by the Formula:

$${v}_{i} ( k + 1 ) = ω {v}_{i} ( k ) + {c}_{1} {r}_{1} ( {p}_{i} ( k ) - {x}_{i} ( k ) ) + {c}_{2} {r}_{2} ( {P}_{g l o b a l} ( k ) ) - {x}_{i} ( k )$$

$${x}_{i} ( k + 1 ) = {x}_{i} ( k ) + {v}_{i} ( k + 1 )$$

In particular, xᵢ(k) indicates the position of the i particle in the k iteration; vᵢ(k) indicates the velocity of the particle; pᵢ(k) indicates the optimal position of the particle; P_{global}(k) indicates the global optimal position of the particle; ω indicates the weight of the adjustable parameter; c₁ indicates the preset individual learning factor; c₂ indicates the preset group learning factor; r₁ and r₂ are random numbers with value range of (0,1], which are used to increase search randomness. After multiple iterations, when the objective function reaches the global optimum, the iteration is stopped and the adjustment values of the adjustable parameters are output. The adjustment values can be the difference between the optimal parameter combination and the current adjustable parameters, or the values of each adjustable parameter in the optimal parameter combination. The deep space in-situ spectrometer automatically adjusts the adjustable parameters according to the adjustment values and performs detection. It can be understood that, in addition to the above-mentioned particle swarm optimization algorithm, a swarm intelligence optimization algorithm such as a differential evolution algorithm may also be used to calculate the adjustment values.

In order to further improve the efficiency and accuracy of the swarm intelligence optimization algorithm, the model can also be trained using the actual on-orbit historical control parameter data of the deep space in-situ spectrometer and the control parameter data in the simulation environment. Through the training, the swarm intelligence optimization algorithm can better understand and adapt to the control needs in different scenarios. While ensuring the quantitative level, it can continuously optimize its own parameters and structure to improve scene adaptability and control accuracy.

The present disclosure also provides a multi-level and multi-parameter coupling regulation device, including one or more processors, a memory,
one or more computer programs. In particular, the one or more computer programs are stored in the memory, the one or more computer programs include instructions, the instructions are executed by the one or more processors, so that the multi-level and multi-parameter coupling regulation device performs the above-mentioned multi-level and multi-parameter coupling regulation method.

The present disclosure also provides an electronic equipment, including at least one processors, and a memory communicatively connected to the at least one processors. In particular, the memory stores instructions executable by the at least one processors, the instructions are executed by the at least one processors, so that the at least one processors are able to perform the above-mentioned multi-level and multi-parameter coupling regulation method.

The present disclosure also provides a non-transitory computer-readable storage medium storing computer instructions. The computer instructions are used to enable a computer to perform the above-mentioned multi-level and multi-parameter coupling regulation method.

### Example 2

Example 2 of the present disclosure also provides a multi-parameter regulation method, including the following steps:
acquiring scene analysis information, constructing a scene characteristic function.
acquiring the preset adjustable parameters and the adjustment weights of the adjustable parameters, and constructing the adjustable parameter function according to the adjustable ranges of the adjustable parameters.
acquiring the pre-collected spectral data and the signal-to-noise ratio of the data, the signal-to-noise ratio of the data is used as the optimized objective function, and constructing a mathematical model that can reflect the relationship between the signal-to-noise ratio of the data and the scene characteristic function and the adjustable parameter function.
selecting the suitable swarm intelligence optimization algorithm, iteratively solving the optimal parameter combination, calculating the difference between the optimal parameter combination and the actual adjustable parameters, that is, the adjustment value, outputting the adjustment value, and adjusting the adjustable parameters according to the adjustment value.

The swarm intelligence optimization algorithm still chooses the particle swarm optimization algorithm as an example, with the preset swarm size as N, the number of iterations as T, and the adjustment values of the adjustable parameters as the particle. The adjustment values are the minimum step size of the adjustable parameter. The optimal parameter combination is solved by the Formula:

$${v}_{i} ( k + 1 ) = ω {v}_{i} ( k ) + {c}_{I} {r}_{1} ( {p}_{i} ( k ) - {x}_{i} ( k ) ) + {c}_{2} {r}_{2} ( {P}_{g l o b a l} ( k ) ) - {x}_{i} ( k )$$

$${x}_{i} ( k + 1 ) = {x}_{i} ( k ) + {v}_{i} ( k + 1 )$$

In particular, xᵢ(k) indicates the position of the i particle in the k iteration; vᵢ(k) indicates the velocity of the particle; pᵢ(k) indicates the optimal position of the particle; P_{global}(k) indicates the global optimal position of the particle; ω indicates the weight of the adjustable parameter; c₁ indicates the preset individual learning factor; c₂ indicates the preset group learning factor; r₁ and r₂ are random numbers which are used to increase search randomness. After multiple iterations, when the objective function reaches the global optimum, the iteration is stopped and the adjustment values of the adjustable parameters are output. The deep space in-situ spectrometer automatically adjusts the adjustable parameters according to the adjustment values and performs detection.

The above are all preferred embodiments of the disclosure, and do not limit the scope of protection of the disclosure. Therefore, any equivalent changes made based on the structure, shape, and principle of the disclosure shall be covered by the protection scope of the disclosure.

What is claimed is:

1. A multi-level and multi-parameter coupling regulation method, comprising following steps:
acquiring multi-source scene data, analyzing the multi-source scene data, and generating scene analysis information;
calculating adjustment weights of preset adjustable parameters according to the multi-source scene data;
calculating adjustment values of the preset adjustable parameters through a swarm intelligence optimization algorithm according to the scene analysis information and the adjustment weights; and
adjusting the preset adjustable parameters according to the adjustment values.

2. The multi-level and multi-parameter coupling regulation method according to claim 1, wherein the multi-source scene data comprises telemetry data of deep space in-situ spectrometer, current values of the preset adjustable parameters, and pre-collected spectral data using the current values of the preset adjustable parameters.

3. The multi-level and multi-parameter coupling regulation method according to claim 2, wherein when the multi-source scene data is analyzed, extracting a maximum (DNₘₐₓ), a minimum (DNₘᵢₙ), and an average (DNₘₑₐₙ) in the pre-collected spectral data, and the method comprises following step:
calculating a signal-to-noise ratio (SNR_{y}) of the pre-collected spectral data.

4. The multi-level and multi-parameter coupling regulation method according to claim 3, wherein the method comprises following step:
optimizing the signal-to-noise ratio (SNR_{y}) of the pre-collected spectral data as an objective function of the swarm intelligence optimization algorithm.

5. The multi-level and multi-parameter coupling regulation method according to claim 4, wherein in the swarm intelligence optimization algorithm, the method comprises following steps:
constructing an adjustable parameter function according to adjustable ranges of the preset adjustable parameters;
constructing a scene characteristic function according to the scene analysis information; and
constructing a mathematical model between the signal-to-noise ratio (SNR_{y}) of the pre-collected spectral data and the adjustable parameter function and the scene characteristic function according to the adjustable parameter function and the scene characteristic function.

6. The multi-level and multi-parameter coupling regulation method according to claim 2, wherein the preset adjustable parameters comprise a spectral detection observation angle, a field diaphragm specification of the deep space in-situ spectrometer, an input radio frequency (RF) power of an in-situ spectral spectroscopic part, a modulation frequency of RF power amplifier, and a gain of electronics and integration time of detectors.

7. The multi-level and multi-parameter coupling regulation method according to claim 1, wherein calculating the adjustment weights comprises following steps:
constructing a correlation analysis database of the preset adjustable parameters, recording changes when a certain adjustable parameter of the preset adjustable parameters is fixed and other adjustable parameters of the preset adjustable parameters are changed one by one; and
calculating the adjustment weights of each of the preset adjustable parameters using the multi-source scene data as input variables based on a fuzzy logic algorithm and outputting the adjustment weights.

8. A multi-level and multi-parameter coupling regulation device, comprising
one or more processors,
a memory, and
one or more computer programs, wherein the one or more computer programs are stored in the memory, the one or more computer programs comprise instructions, and the instructions are executed by the one or more processors, so that the multi-level and multi-parameter coupling regulation device performs the multi-level and multi-parameter coupling regulation method according to claim 1.

9. Electronic equipment, comprising at least one processor, and a memory communicatively connected to the at least one processor, wherein the memory stores instructions executable by the at least one processor, and the instructions are executed by the at least one processor, so that the at least one processor is configured to perform the multi-level and multi-parameter coupling regulation method according to claim 1.

10. A non-transitory computer-readable storage medium storing computer instructions, wherein the computer instructions are used to enable a computer to perform the multi-level and multi-parameter coupling regulation method according to claim 1.
